(19) United States
(12) Patent Application Publication
(10) Pub. No.: US 2013/0183031 A1
(43) Pub. Date: Jul. 18, 2013

(54) DATA TRANSMISSION DEVICE, DATA TRANSMISSION METHOD, AND DATA TRANSMISSION DEVICE CONTROL PROGRAM

(71) Applicant: FUJIKURA LTD., Tokyo (JP)

(72) Inventor: Shinya ABE, Toyko (JP)

(73) Assignee: FUJIKURA LTD., Tokyo (JP)

(21) Appl. No.: 13/788,984

(22) Filed: Mar. 7, 2013

Related U.S. Application Data
(63) Continuation of application No. PCT/JP2011/067538, filed on Jul. 29, 2011.

(30) Foreign Application Priority Data
Sep. 10, 2010 (JP) 2010-203349

(51) Int. Cl. H04B 10/2507

(52) U.S. Cl. CPC H04B 10/2507
USPC 398/25

(57) ABSTRACT

A data transmission device may include: a transmitter unit; a receiver unit; an optical transmission path that connects the transmitter unit to the receiver unit and transmits an optical signal; and an electrical transmission path that connects the transmitter unit to the receiver unit and transmits an electrical signal. The transmitter unit may include: a light source unit that converts an input electrical signal from an exterior into an optical signal, and outputs the optical signal to the optical transmission path; and a transmitter-side control unit that outputs information on a physical quantity having a relation to intensity of the optical signal, which is output from the light source unit, to the electrical transmission path. The receiver unit may include: a light detecting unit that receives the optical signal transmitted through the optical transmission path and converts the optical signal into an electrical signal; and a receiver-side control unit.

### CROSS REFERENCE TO RELATED APPLICATIONS

This application is a continuation application based on a PCT Patent Application No. PCT/JP2011/067538, filed Jul. 29, 2011, whose priority is claimed on Japanese Patent Application No. 2010-203349, filed Sep. 10, 2010, the entire content of which are hereby incorporated by reference.

### BACKGROUND OF THE INVENTION

1. Field of the Invention

The present invention relates to a data transmission device, a data transmission method, and a data transmission device control program.

2. Description of the Related Art

A camera link interface has been standardized as a scheme of transmitting a signal between a camera and a processing apparatus (“CameraLink Specifications of the Camera Link Interface Standard for Digital Cameras and Frame Grabbers”, October 2000, and Japanese Unexamined Patent Application, First Publication No. 2007-116734). According to the scheme, a total of 11 pairs of signal lines and a plurality of shield lines are accommodated in one cable, wherein the total of 11 pairs of signal lines include signal lines for video signals (four pairs of video signals and one pair of clock signals) from the camera, control lines (four pairs) for shutter signals, and serial signal lines (two pairs of transmission signals and reception signals) with the camera. Furthermore, in order to enhance noise resistance, signal transmission in a metal cable is performed such that a non-inverted signal and an inverted signal are transmitted as a pair using a signal scheme called LVDS (Low Voltage Differential Signaling).

FIG. 14 is an internal wiring diagram of one example (Base Configuration which is a kind of camera link standard) of a camera link interface in accordance with the related art. A camera link interface 2 includes a camera-side connector case unit 400, a metal cable 500, and a processing apparatus-side connector case unit 600. In FIG. 14, respective terminals of the camera-side connector case unit 400 are connected to respective differential lines or shield lines in the metal cable 500 through signal lines in the camera-side connector case unit 400. Furthermore, the respective differential lines or shield lines in the metal cable 500 are connected to respective terminals of the processing apparatus-side connector case unit 600 through signal lines in the processing apparatus-side connector case unit 600. Furthermore, the camera-side connector case unit 400 and the processing apparatus-side connector case unit 600 in the camera link interface 2 have 26 pin connector terminals, respectively.

As an interface other than the camera link, there is a high speed serial bus standard called USB (Universal Serial Bus) or IEEE 1394. However, differently from USB and IEEE 1394, since the camera link independently has a control line for transmitting an imaging timing unique to a camera, or a control line for instructing an exposure time from a processing apparatus to the camera, the camera link is a general interface as a scheme for transmitting a signal between the camera and the processing apparatus at the present time.

In the camera link interface standard, a transmission distance is defined to 10 m at maximum. However, in the case of transmitting a video signal with high resolution, the transmission distance is limited to 7 to 8 m. Furthermore, in order to improve transmission quality, a diameter of a cable is increased, resulting in the reduction of the flexibility of the cable. Therefore, it is not suitable for the purpose of space saving and mobility.

In this regard, Japanese Unexamined Patent Application, First Publication No. 2007-116734 discloses a method for collecting a plurality of differential signal lines into one line using a time division multiplexing scheme to reduce the number of signal lines. Furthermore, there have been proposed a scheme of converting a video signal into light using an electrical/optical conversion unit provided in a connector case of DVI (refer to Japanese Patent Publication No. 4345652), and a scheme of combining the scheme of Japanese Unexamined Patent Application, First Publication No. 2007-116734 with the scheme of Japanese Patent Publication No. 4345652 (refer to Japanese Unexamined Patent Application, First Publication No. 2010-50847), in transmission between a video signal source such as a DVD recorder and a large display.

When the scheme of Japanese Patent Publication No. 4345652 is employed, a high speed video signal is converted into an optical signal using the electrical/optical conversion unit provided in the connector case of the camera link interface, and the optical signal is transmitted using an optical fiber as a transmission path, there is a merit in that a data transmission device serving as the camera link interface is able to transmit the optical signal over a long distance, the mixing of noise in the optical signal is reduced, and the diameter of a transmission cable can be reduced. However, the lifespan of optical units, such as LDs (Laser Diodes) or PDs (Photo Diodes), is known to be about 1/10 of the lifespan of cables or electronic units, and the risk of signal transmission interruption due to malfunction of the optical units is high. In this regard, when internal transmission is performed using the optical signal, the data transmission device serving as the camera link interface needs to have a function of detecting the abnormality of internal optical units and notifying of the abnormality externally.

In an optical module for communication, a function (refer to Japanese Patent Publication No. 3822861) of diagnosing an internal state and notifying an external apparatus (a host) of an alarm through a serial interface has been known. However, since mounting optical units has not been considered in the camera link interface, there is no definition for a method for providing a function of notifying the external apparatus of the internal state including the state of the optical units.

### SUMMARY

The present invention provides a data transmission device capable of allowing a receiver side of an optical signal to determine the abnormality of optical units of a transmitter side, a data transmission method, and a data transmission device control program.

A data transmission device may include: a transmitter unit; a receiver unit; an optical transmission path that connects the transmitter unit to the receiver unit and transmits an optical signal; and an electrical transmission path that connects the transmitter unit to the receiver unit and transmits an electrical signal. The transmitter unit may include: a light source unit that converts an input electrical signal from an exterior into an optical signal, and outputs the optical signal to the optical transmission path; and a transmitter-side control unit that outputs information on a physical quantity having a relation to intensity of the optical signal, which is output from the light source unit, to the electrical transmission path. The receiver unit may include: a light detecting unit that receives the optical signal transmitted through the optical transmission path and converts the optical signal into an electrical signal; and a receiver-side control unit that receives the information on the physical quantity transmitted through the electrical transmission path, and determines abnormality of the light source unit based on the received information on the physical quantity.

The transmitter unit may further include a light source driving unit that controls a bias current output to the light source unit. The information on the physical quantity may be information indicating ambient temperature of the light source unit. The receiver-side control unit may transmit a setting value of the bias current for controlling the intensity of the optical signal of the light source unit to the transmitter-side control unit based on the received information indicating the ambient temperature. The transmitter-side control unit may control the light source driving unit based on the setting value of the bias current received from the receiver-side control unit. The receiver-side control unit may determine the abnormality of the light source unit based on information on the intensity of the optical signal received in the light detecting unit.

When an intensity ratio of an optical signal at a present time to intensity of a reference optical signal is out of a predetermined range, the receiver-side control unit may determine that the light source unit is abnormal.

The transmitter unit may further include: a light detection unit that detects the intensity of the optical signal output from the light source unit; and a light source driving unit that controls a bias current output to the light source unit such that the intensity of the optical signal detected by the light detection unit is constant. The information on the physical quantity may be information indicating the bias current of the light source unit. The receiver-side control unit may determine the abnormality of the light source unit based on information indicating the received bias current.

When a bias current ratio at a present time to a reference bias current is out of a predetermined range, the receiver-side control unit may determine that the light source unit is abnormal.

The information on the physical quantity may be information indicating ambient temperature of the light source unit. The receiver-side control unit may adjust the intensity of the received optical signal to intensity of an optical signal at a reference temperature based on the information indicating the ambient temperature, and determine the abnormality of the light source unit based on information indicating the adjusted intensity of the optical signal.

When a ratio of the adjusted intensity of the optical signal at a present time to intensity of a reference optical signal is out of a predetermined range, the receiver-side control unit may determine that the light source unit is abnormal.

When an input electrical signal from an exterior is a signal having a variable transmission rate, the light transmitter unit may further include a test signal generation unit that generates an electrical signal for a test in synchronization with a clock signal. The light source unit may convert the electrical signal for a test generated by the light transmitter unit into an optical signal for a test, and output the optical signal for a test to the optical transmission path. The light detecting unit may receive the optical signal for a test transmitted through the optical transmission path, and convert the optical signal for a test into the electrical signal for a test. The light detecting unit may further include a clock signal regeneration unit that regenerates the clock signal from the electrical signal for a test converted by the light detecting unit. When it is possible to regenerate the clock signal, the clock signal regeneration unit may transmit a completion signal indicating completion of regeneration of the clock signal to the receiver-side control unit. The receiver-side control unit may output the completion signal transmitted by the clock signal regeneration unit to the electrical transmission path. The transmitter-side control unit may transmit the completion signal transmitted through the electrical transmission path to the test signal generation unit.

The data transmission device may further include: a light emitting element that emits light. The receiver-side control unit may perform control such that a lighting state of the light emitting element is changed when it is determined that the light source unit is abnormal.

The data transmission device may further include: a switch unit that outputs a signal input from the receiver-side control unit to an external apparatus. When information indicating the abnormality of the light source unit is requested, the receiver-side control unit may perform control such that the information is output to the external apparatus through the switch unit.

A data transmission method performed in the data transmission device may include: a transmitter-side control sequence of outputting information on a physical quantity having a relation to intensity of an optical signal, which is output from the light source unit, to the electrical transmission path; and a receiver-side control sequence of receiving the information on the physical quantity transmitted through the electrical transmission path, and determining abnormality of the light source unit based on the received information on the physical quantity.

A data transmission device control program may cause a computer of a receiver-side control unit of a receiver unit in a data transmission device to perform: receiving information on a physical quantity transmitted through an electrical transmission path, and determining abnormality of a light source unit based on the received information on the physical quantity. The data transmission device may include: a transmitter unit; the receiver unit; and the electrical transmission path that connects the transmitter unit to the receiver unit and transmits an electrical signal. The transmitter unit may include: the light source unit that converts an input electrical signal from an exterior into an optical signal, and outputs the optical signal to the optical transmission path; and a transmitter-side control unit that outputs the information on the physical quantity having a relation to intensity of the optical signal, which is output from the light source unit, to the electrical transmission path.

According to the preferred embodiment of the present invention, it is possible for a receiver side of an optical signal to determine the abnormality of optical units of a transmitter side.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a functional block diagram of a data transmission device in accordance with a first preferred embodiment of the present invention;

FIG. 2 is a timing chart for explaining a video signal format and a timing of a clock signal;

FIG. 3 is a functional block diagram of a camera-side MCU (a transmitter-side control unit);

FIG. 4 is a diagram for explaining a relation between an input current signal and an optical output signal in a VCSEL;

FIG. 5 is a diagram illustrating a change in light output power by a bias current of the VCSEL;

FIG. 6 is a functional block diagram of a processing apparatus-side MCU (a receiver-side control unit);

FIG. 7 is a diagram illustrating an example of a look up table stored in a memory of the processing apparatus-side MCU (the receiver-side control unit);

FIG. 8A is a diagram for explaining an establishment procedure of a synchronization between an LVDS serializer (a test signal generation unit) and an LVDS deserializer (a clock signal regeneration unit);

FIG. 8B is a diagram for explaining the establishment procedure of the synchronization between the LVDS serializer (the test signal generation unit) and the LVDS deserializer (the clock signal regeneration unit);

FIG. 9 is a table for explaining an example of pin arrangement of input/output terminals of the data transmission device;

FIG. 10 is a flowchart illustrating the flow of the process of the camera-side MCU (the transmitter-side control unit);

FIG. 11 is a flowchart illustrating the flow of the process of the processing apparatus-side MCU (the receiver-side control unit);

FIG. 12 is a flowchart illustrating the flow of the process of the processing apparatus-side MCU (the receiver-side control unit) at the time of interrupt in accordance with the first preferred embodiment of the present invention;

FIG. 13 is a functional block diagram of a data transmission device in accordance with a second preferred embodiment of the present invention; and

FIG. 14 is an internal wiring diagram of one example (Base Configuration which is a kind of camera link standard) of a camera link interface in accordance with the related art.

### DETAILED DESCRIPTION OF THE PREFERRED EMBODIMENTS

The present invention will be now described herein with reference to illustrative embodiments. Those skilled in the art will recognize that many alternative embodiments can be accomplished using the teaching of the present invention and that the present invention is not limited to the embodiments illustrated for explanatory purpose.

### First Preferred Embodiment

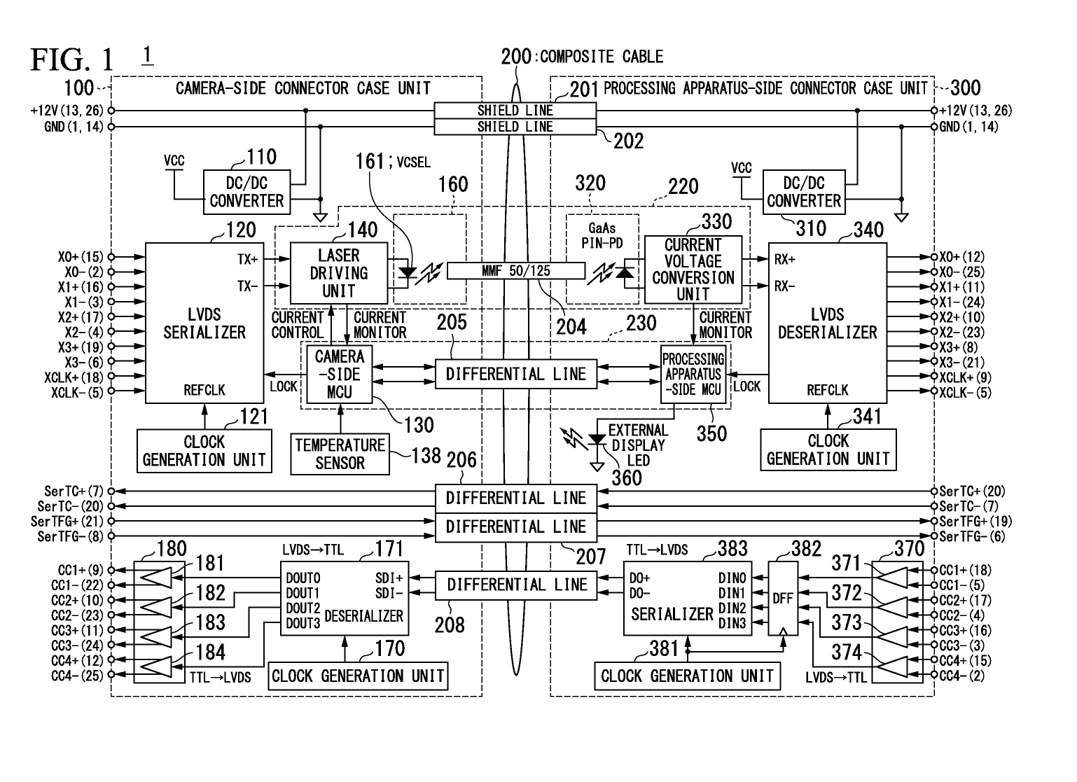

FIG. 1 is a functional block diagram of a data transmission device in accordance with a first preferred embodiment of the present invention. A data transmission device 1 includes a camera-side connector case unit (a transmitter unit) 100, a composite cable 200, and a processing apparatus-side connector case unit (a receiver unit) 300. Furthermore, a light transmitting/detecting unit 220 includes a laser driving unit (a light source driving unit) 140, a laser unit (a light source unit) 160, an optical fiber (a light transmission path) 204, a light detecting unit 320, and a current voltage conversion unit 330. Furthermore, a control unit 230 includes a camera-side MCU (a transmitter-side control unit) 130, a differential line (an electrical transmission path) 205, and a processing apparatus-side MCU (a receiver-side control unit) 350.

The camera-side connector case unit (the transmitter unit) 100 includes a DC/DC converter 110, an LVDS serializer (a test signal generation unit) 120, a clock generation unit 121, the camera-side MCU (the transmitter-side control unit) 130, a temperature sensor 138, the laser driving unit (the light source driving unit) 140, the laser unit (the light source unit) 160, a clock generation unit 170, a deserializer 171, and a level conversion unit 180. Furthermore, “MCU” of the camera-side MCU (the transmitter-side control unit) 130 is an abbreviation for “Micro Control Unit” (a microcontroller). Each element of the camera-side connector case unit (the transmitter unit) 100, for example, is accommodated in a SDR-26 connector case.

The DC/DC converter 110 converts a direct current voltage (+12 V) supplied from a processing apparatus (not illustrated) through a shield line 201 into a predetermined voltage, and uses the converted voltage as a positive power supply voltage VCC.

The LVDS serializer (the test signal generation unit) 120 time-division multiplexes four input video signals Xi+/− (i is 0 to 3) and a clock signal XCLK+/− for a video signal, and converts the multiplexed signals into serial signals.

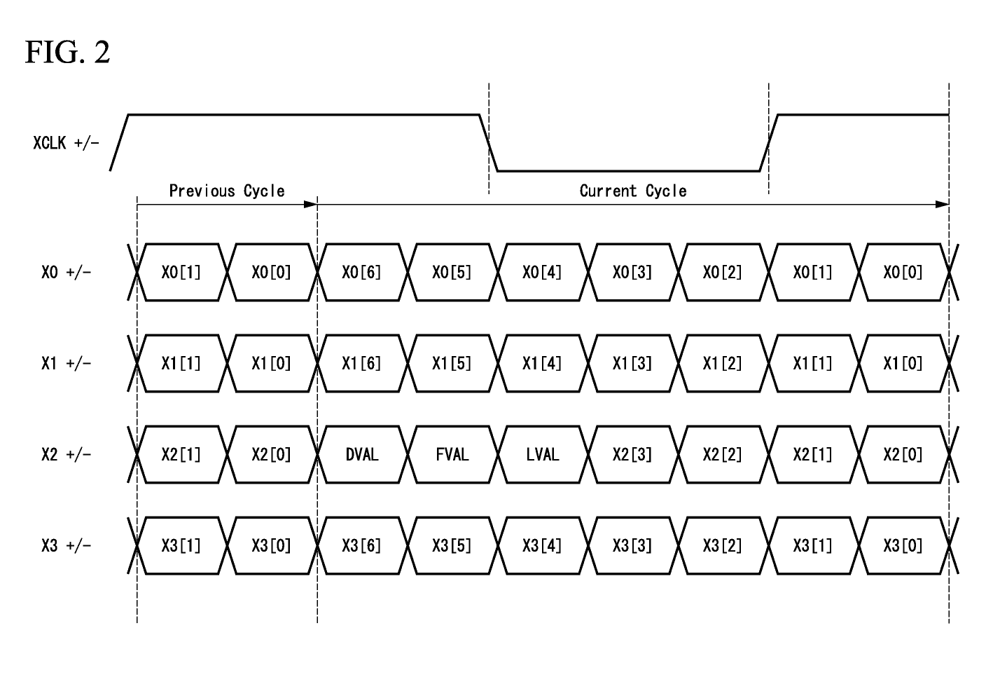

FIG. 2 is a timing chart for explaining a video signal format and a timing of a clock signal. FIG. 2 illustrates voltage variation of the clock signal XCLK+/−, the input video signal X0+/−, the input video signal X1+/−, the input video signal X2+/−, and the input video signal X3+/−.

One cycle signal of the input video signals Xi+/− (i is an integer from 0 to 3) includes Xi [6], Xi [5], Xi [4], Xi [3], Xi [2], Xi [1], and Xi [0]. At the time of one period change of the clock signal XCLK+/−, input video signals Xi [j]+/− (j is an integer from 0 to 6) are input one by one.

For example, when video signals in which a frequency of the clock signal XCLK+/− is 85 MHz are input to the LVDS serializer (the test signal generation unit) 120, each data speed of the input video signals Xi+/− (i is 0 to 3) is 595 Mbps, which is seven times as fast as 85 MHz. The LVDS serializer (the test signal generation unit) 120 multiplexes the input video signals and converts data using an 8 B/10 B encoding scheme. The LVDS serializer (the test signal generation unit) 120 outputs the converted data to the laser driving unit (the light source driving unit) 140 through output terminals TX+/− thereof.

Furthermore, according to the 8 B/10 B encoding scheme, an 8-bit signal is converted into a 10-bit signal by predetermined coding, and a mark rate (a ratio of code 1 to code 0) is set to 50%. As a consequence, a line rate of an optical transmission path corresponds to 1.25 (10/8) times an effective rate. Thus, the speed of the converted data output from the output terminals TX+/− of the LVDS serializer (the test signal generation unit) 120 is 2975 Mbps (=595 Mbps×4×1.25).

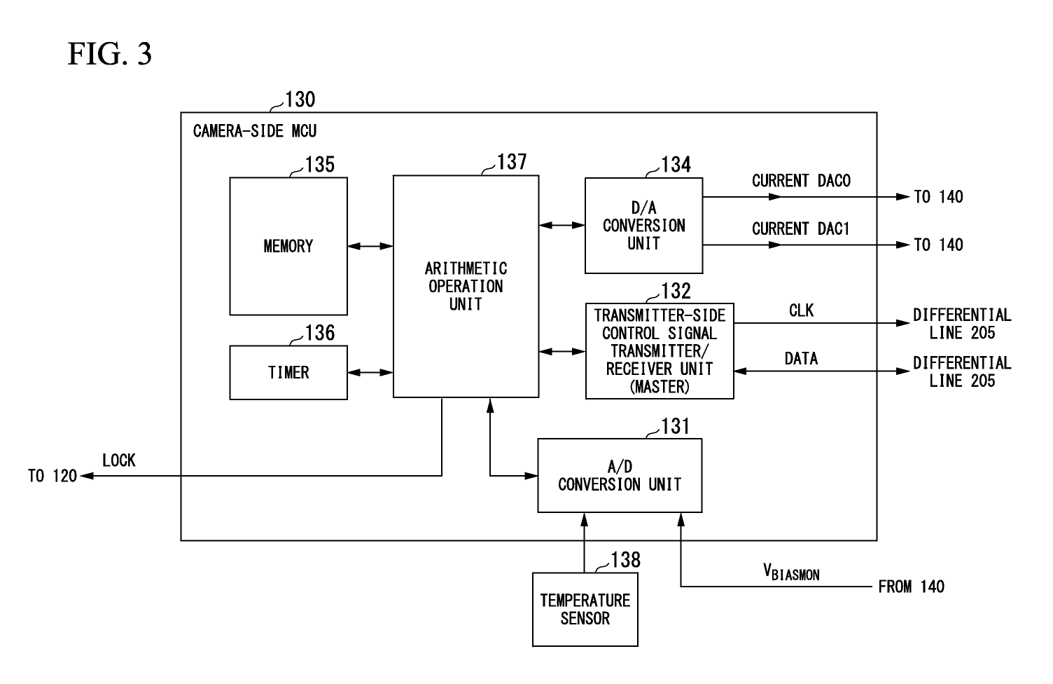

Next, the camera-side MCU (the transmitter-side control unit) 130 will be described. FIG. 3 is a functional block diagram of the camera-side MCU (the transmitter-side control unit). The camera-side MCU (the transmitter-side control unit) 130 includes an A/D conversion unit 131, a transmitter-side control signal transmitter/receiver unit (a master) 132, a D/A conversion unit 134, a memory 135, a timer 136, and an arithmetic operation unit 137.

The role of the camera-side MCU (the transmitter-side control unit) is to (1) acquire a temperature monitor A/D value (an analog-to-digital converted value) which is information indicating the ambient temperature of the laser unit (the light source unit) 160 and a bias current A/D value which is information obtained by monitoring the magnitude of a bias current output to the laser unit (the light source unit) 160; (2) transmit the temperature monitor A/D value and the bias current A/D value from the transmitter-side control signal transmitter/receiver unit 132 to the processing apparatus-side MCU (the receiver-side control unit) 350, which will be described later, through the differential line (the electrical transmission path) 205 (hereinafter referred to as an inner link); (3) acquire a setting value of a bias current and a setting value of a modulation current for controlling the intensity of an optical signal of the laser unit (the light source unit) 160 from the processing apparatus-side MCU (the receiver-side control unit) 350, which will be described later, through the inner link; (4) convert the setting value of the bias current and the setting value of the modulation current into an analog voltage through the D/A conversion unit 134, output the analog voltage to the laser driving unit (the light source driving unit) 140, which will be described later, and set the bias current and the modulation current; (5) acquire LOCK information, which notifies of the completion of regeneration of a reception clock of an LVDS deserializer (a clock signal regeneration unit) 340, which will be described later, in the processing apparatus-side connector case unit (the receiver unit) 300, from the processing apparatus-side MCU (the receiver-side control unit) 350, which will be described later, through the inner link; and (6) output the LOCK information to the LVDS serializer (the test signal generation unit) 120.

The transmitter-side control signal transmitter/receiver unit (the master) 132 communicates with a receiver-side control signal transmitter/receiver unit (a slave) 352, which will be described later, in the processing apparatus-side MCU (the receiver-side control unit) 350 of the processing apparatus-side connector case unit (the receiver unit) 300, through the inner link. In this communication, the camera-side MCU (the transmitter-side control unit) 130 serves as a master (a side that outputs a request) and the processing apparatus-side MCU (the receiver-side control unit) 350 serves as a slave (a side that receives and processes the request). In addition, in the first preferred embodiment, a two-line serial interface (I2C: Inter-Integrated Circuit) is used. However, an RS-422 or a communication scheme of an independent standard may be used.

With the miniaturization of a camera, since the camera-side connector case unit 100 has a connector with a size smaller than that of the processing apparatus-side connector case unit 300, an arrangement area of electronic units is smaller than that in the processing apparatus side. In this regard, the size of the camera-side MCU (the transmitter-side control unit) needs to be small to a maximum extent.

In the first preferred embodiment, in order to reduce the size of the camera-side MCU (the transmitter-side control unit) 130 to a maximum extent, the camera-side MCU (the transmitter-side control unit) 130 does not perform an interrupt process, calculation of a numerical value based on a numerical expression, determination of a result of the calculation, and the like. Consequently, for example, a program area can be processed by a small MCU (a package of 3 mm×3 mm) of 2 Kbyte or less.

Meanwhile, since the processing apparatus-side MCU (the receiver-side control unit) 350 serves as a slave in the communication between the inner links, the processing apparatus-side MCU (the receiver-side control unit) 350 processes a request from the camera-side MCU (the transmitter-side control unit) 130, which serves as a master, by interrupt. Since the processing apparatus-side MCU (the receiver-side control unit) 350 needs to perform an interrupt process, calculation of a numerical value based on a numerical expression, determination of a result of the calculation, and the like, a program area needs to be an MCU (a package of 5 mm×5 mm) having a program area of about 4 Kbyte to about 8 Kbyte. Since the processing apparatus-side connector case unit (the receiver unit) 300 has a surplus mounting space as compared with the camera-side connector case unit (the transmitter unit) 100, the processing apparatus-side MCU (the receiver-side control unit) 350 is able to perform a high load process as compared with the camera-side MCU (the transmitter-side control unit) 130.

The A/D conversion unit 131 converts an analog voltage, which indicates the ambient temperature of the laser unit (the light source unit) 160 input from the temperature sensor 138, into a temperature monitor A/D value which is temperature information indicating the ambient temperature of a laser. The A/D conversion unit 131 stores the converted temperature monitor A/D value in a RAM area (not illustrated) of the memory 135, which will be described later, through the arithmetic operation unit 137.

Furthermore, the A/D conversion unit 131 A/D-converts a voltage V_{BIASMON}, which indicates a present value of a bias current of the laser unit (the light source unit) 160, which is input from the laser driving unit (the light source driving unit) 140, generates a bias current A/D value, and stores the bias current A/D value in the RAM area (not illustrated) of the memory 135, which will be described later, through the arithmetic operation unit 137.

The transmitter-side control signal transmitter/receiver unit (the master) 132 outputs a clock signal CLK serving as a reference in order to transmit data to the processing apparatus-side MCU (the receiver-side control unit) 350 in the processing apparatus-side connector case unit (the receiver unit) 300 or receive data from the processing apparatus-side MCU (the receiver-side control unit) 350, and transmits or receives a data signal DATA in synchronization with the clock signal CLK. Furthermore, the transmitter-side control signal transmitter/receiver unit (the master) 132 acquires a LOCK signal, which notifies of the completion of clock regeneration of the LVDS deserializer (the clock signal regeneration unit) 340 from the processing apparatus-side MCU (the receiver-side control unit) 350, and outputs the LOCK signal to the LVDS serializer (the test signal generation unit) 120 through the arithmetic operation unit 137.

Furthermore, the transmitter-side control signal transmitter/receiver unit (the master) 132 transmits the temperature monitor A/D value and the bias current A/D value to the processing apparatus-side MCU (the receiver-side control unit) 350 through the inner link. Furthermore, the transmitter-side control signal transmitter/receiver unit (the master) 132 stores information on the setting value of the bias current and information on the setting value of the modulation current, which are received from the processing apparatus-side MCU (the receiver-side control unit) 300, in the RAM area (not illustrated) of the memory 135, which will be described later, through the arithmetic operation unit 137.

The D/A conversion unit 134 digital-to-analog (D/A)-converts the information on the setting value of the modulation current, which is acquired from the RAM area (not illustrated) of the memory 135 (which will be described later) through the arithmetic operation unit 137, and outputs a converted current DAC0 to the laser driving unit (the light source driving unit) 140 which will be described later.

Furthermore, the D/A conversion unit 134 D/A-converts the information on the setting value of the bias current, which is acquired from the RAM area (not illustrated) of the memory 135 (which will be described later) through the arithmetic operation unit 137, and outputs a converted current DAC1 to the laser driving unit (the light source driving unit) 140 which will be described later.

The memory 135 is divided into a RAM (Read Access Memory) area (not illustrated) and a Flash ROM (Read Only Memory) area (not illustrated). The RAM area (not illustrated) stores data to be primarily stored and the ROM area (not illustrated) stores a predetermined program to be executed by the arithmetic operation unit 137.

The timer 136 generates a request flag at a predetermined interval (for example, 10 ms). The arithmetic operation unit 137 always monitors the state of the flag, and starts a process of data exchange, A/D/D/A conversion, communication and the like using the request flag as a trigger.

When power is applied, the arithmetic operation unit 137 starts to read a program from the ROM area (not illustrated) of the memory 135, initializes input/output signal terminals thereof according to a procedure of the program, initializes the A/D conversion unit 131, the transmitter-side control signal transmitter/receiver unit (the master) 132, the D/A conversion unit 134, and the timer 136, and starts to operate the timer 136.

The arithmetic operation unit 137 always monitors the request flag from the timer 136, and resets an initial timer value of the timer 136 using the generation of the request flag as a trigger. Furthermore, the arithmetic operation unit 137 starts the operation of the A/D conversion unit 131, and stores the temperature monitor A/D value and the bias current A/D value, which are output from the A/D conversion unit 131, in the RAM area (not illustrated) of the memory 135. Furthermore, the arithmetic operation unit 137 controls the transmitter-side control signal transmitter/receiver unit (the master) 132, thereby outputting the temperature monitor A/D value and the bias current A/D value, which are stored in the RAM area (not illustrated) of the memory 135, to the processing apparatus-side MCU (the receiver-side control unit) 350.

Furthermore, the arithmetic operation unit 137 controls the transmitter-side control signal transmitter/receiver unit (the master) 132, thereby receiving setting information of the bias current and setting information of the modulation current, which are output from the processing apparatus-side MCU (the receiver-side control unit) 350. The arithmetic operation unit 137 stores the received data in the RAM area (not illustrated) of the memory 135.

Furthermore, the arithmetic operation unit 137 controls the D/A conversion unit 134, thereby outputting the setting information of the bias current and the setting information of the modulation current, which are stored in the RAM area (not illustrated) of the memory 135, as an analog current value.

Furthermore, the arithmetic operation unit 137 controls the transmitter-side control signal transmitter/receiver unit (the master) 132, thereby outputting the LOCK information of the LVDS deserializer (the clock signal regeneration unit) 340 (which will be described later) in the processing apparatus-side connector case unit (the receiver unit) 300, which is output from the processing apparatus-side MCU (the receiver-side control unit) 350, to the LVDS serializer (the test signal generation unit) 120.

Next, the laser driving unit (the light source driving unit) 140 will be described. The laser driving unit (the light source driving unit) 140 converts data, which is input from the LVDS serializer (the test signal generation unit) 120, into a bias current I_{BIAS} and a modulation current I_{MOD} using an analog voltage indicating the setting value of the bias current and an analog voltage indicating the setting value of the modulation current, which are input from the camera-side MCU (the transmitter-side control unit) 130. The laser driving unit (the light source driving unit) 140 outputs a current signal, which corresponds to the sum of the bias current I_{BIAS} and the modulation current I_{MOD}, to the laser unit (the light source unit) 160.

The laser driving unit (the light source driving unit) 140 generates the voltage V_{BIASMON}, which indicates the present value of the bias current of the laser unit (the light source unit) 160, using the analog voltage indicating the setting value of the bias current output from the camera-side MCU (the transmitter-side control unit) 130, and outputs the generated voltage V_{BIASMON} indicating the present value of the bias current to the camera-side MCU (the transmitter-side control unit) 130.

Subsequently, the laser unit (the light source unit) 160 includes a vertical cavity surface emitting laser (hereinafter referred to as VCSEL) 161. The VCSEL 161 receives the current signal, which corresponds to the sum of the bias current I_{BIAS} and the modulation current I_{MOD}, which is output from the laser driving unit (the light source driving unit) 140, and outputs an optical signal modulated by the intensity of light emission power to the optical fiber (the light transmission path) 204.

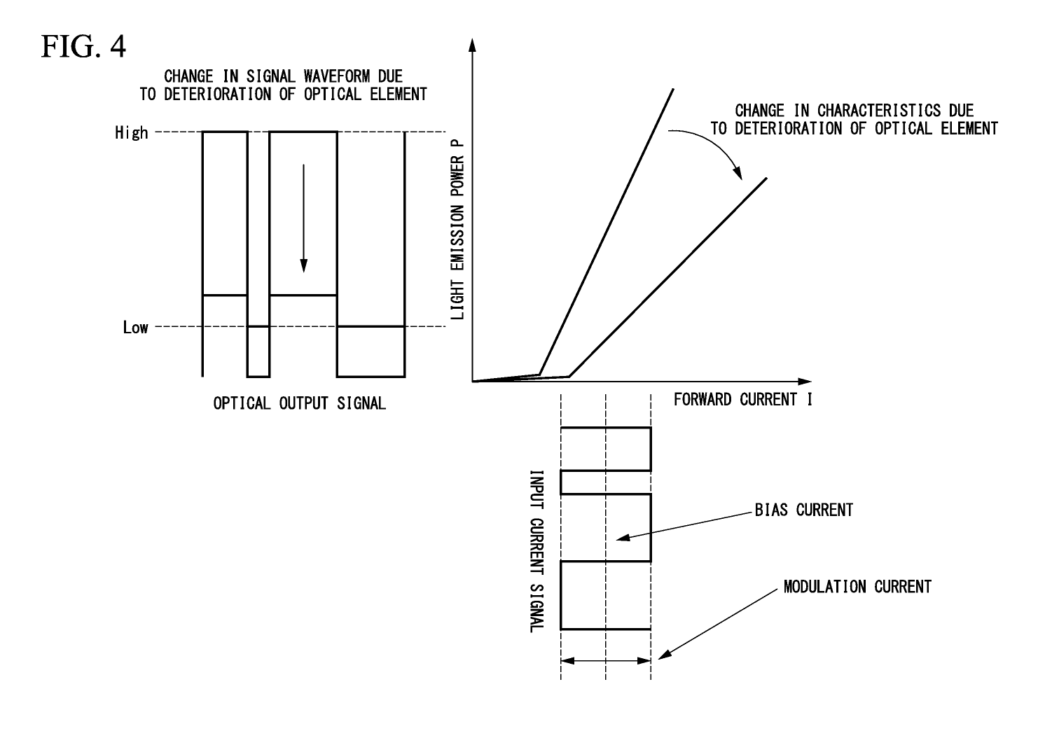

FIG. 4 is a diagram for explaining a relation between an input current signal and an optical output signal in the VCSEL. In FIG. 4, a horizontal axis denotes a forward current I according to the VCSEL and a vertical axis denotes light emission power P of laser light. The input current signal is changed in the form of a rectangular wave with a width of a modulation current about a bias current. In this case, the light emission power of the laser light is changed with respect to light emission power corresponding to the bias current.

When the VCSEL 161 deteriorates, a threshold current is increased, resulting in the reduction of the quantity (a slope in FIG. 4) of the light emission power P which changes to approximate the unit forward current I. In this case, even when the same input current is output, the center level (light emission power at the time of input of the bias current) of the light emission power P of the laser light of the VCSEL 161 is reduced.

The aforementioned phenomenon at the time of the deterioration of the VCSEL 161 shows the same trend as that when the temperature of the VCSEL 161 is increased. This is because light emission efficiency is reduced by crystal defect of the VCSEL 161, and thus energy is changed into heat by the reduction. That is, a heat generation quantity is increased by the reduction of the light emission efficiency, resulting in an increase of the crystal defect of the VCSEL 161. When the crystal defect is increased, the light emission efficiency is further reduced. These series of flows are repeated, so that light emission is finally stopped.

In addition, the abnormality of the laser unit (the light source unit) 160 in the first preferred embodiment is assumed to include a case in which position deviation and the like of a light coupling unit (a lens and the like) between the VCSEL 161 and the optical fiber (the light transmission path) 204 has occurred, a case in which the ambient temperature of the laser unit (the light source unit) 160 is out of a temperature range in which the laser unit (the light source unit) 160 is able to normally operate, and the like, as well as the deterioration of the VCSEL 161. Due to the abnormality, even when the same input current is output, light emission power may be increased in contrast to the time of the deterioration of the VCSEL 161.

Returning to FIG. 1, the laser driving unit (the light source driving unit) 140 controls the input current signal such that the center level (light emission power at the time of input of the bias current) of the optical output signal and an extinction ratio are constant.

Furthermore, an extinction ratio E (dB) of an optical signal output from the VCSEL is expressed by the following Equation 1.

E=10×log(P_{High}/P_{Low}) Equation 1

In Equation above, P_{High} denotes maximum light emission power when an input current signal is output and P_{Low} denotes minimum light emission power when the input current signal is output.

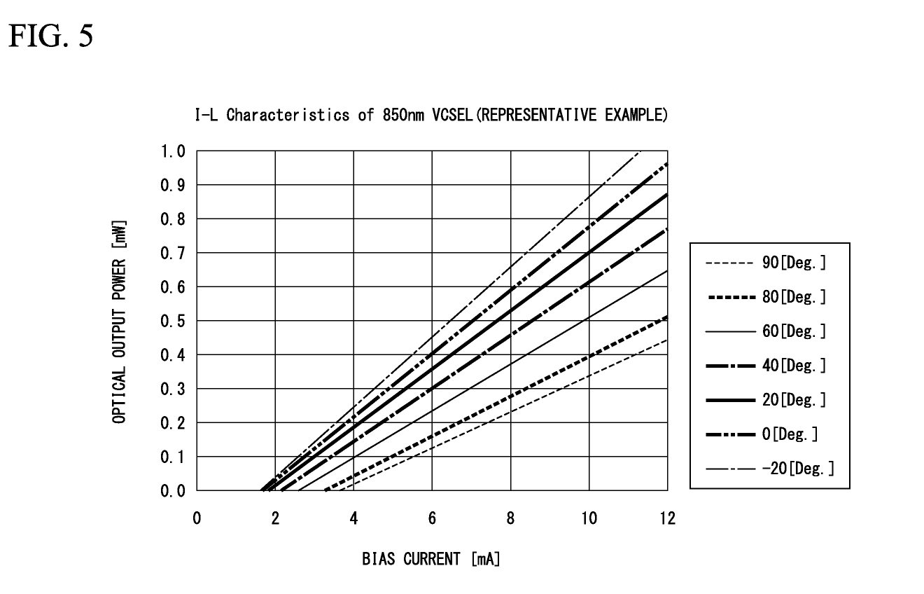

FIG. 5 is a diagram illustrating a change in light output power by the bias current of the VCSEL. In FIG. 5, a horizontal axis denotes a bias current [mA] and a vertical axis denotes light output power [mW] of the VCSEL 161 having a wavelength of 850 nm. In FIG. 5, the light output power linearly changes with respect to the bias current. Furthermore, when the temperature of the VCSEL is increased, a threshold current for outputting laser light is increased with the increase in the temperature. Furthermore, with the increase in the temperature of the VCSEL, the light output power is reduced.

Subsequently, returning to FIG. 1, the clock generation unit 170 outputs a clock signal to the deserializer 171. The deserializer 171 converts an LVDS signal (SDI+/−), which is a time-division multiplexed control signal output from a serializer 383 (which will be described later) of the processing apparatus-side connector case unit (the receiver unit) 300 through a differential line 208, into four TTL (Transistor Transistor Logic) signals DOUT0, DOUT1, DOUT2, and DOUT3 in synchronization with the clock signal. Furthermore, the control signal, for example, is a trigger signal for controlling a shutter timing of a camera.

The deserializer 171 outputs the converted TTL signal DOUT0 to a buffer 181 (which will be described later) of the level conversion unit 180. Similarly, the deserializer 171 outputs the converted TTL signal DOUT1 to a buffer 182 (which will be described later) of the level conversion unit 180. Similarly, the deserializer 171 outputs the converted TTL signal DOUT2 to a buffer 183 (which will be described later) of the level conversion unit 180. Similarly, the deserializer 171 outputs the converted TTL signal DOUT3 to a buffer 184 (which will be described later) of the level conversion unit 180.

The level conversion unit 180 includes the buffer 181, the buffer 182, the buffer 183, and the buffer 184.

The buffer 181 converts the TTL signal DOUT0 input from the deserializer 171 into an LVDS signal which is a differential signal, and outputs the LVDS signal to output terminals CC1+/−. Similarly, the buffer 182 converts the TTL signal DOUT1 input from the deserializer 171 into an LVDS signal which is a differential signal, and outputs the LVDS signal to output terminals CC2+/−.

Similarly, the buffer 183 converts the TTL signal DOUT2 input from the deserializer 171 into an LVDS signal which is a differential signal, and outputs the LVDS signal to output terminals CC3+/−. Similarly, the buffer 184 converts the TTL signal DOUT3 input from the deserializer 171 into an LVDS signal which is a differential signal, and outputs the LVDS signal to output terminals CC4+/−.

Next, the composite cable 200 will be described. The composite cable 200 is a cable including an optical cable and a metal cable. The composite cable 200 includes an optical cable 204, a shield line 201 which is a metal line, a shield line 202, the differential line (the electrical transmission path) 205, a differential line 206, a differential line 207, and a differential line 208.

The shield line 201 is a power line for supplying power from a processing apparatus (not illustrated) to a camera (not illustrated) and electronic units in the camera-side connector case unit 100. Furthermore, the shield line 202 is a signal ground (GND) line of the camera (not illustrated) and the electronic units in the camera-side connector case unit 100.

The optical fiber (the optical transmission path) 204, for example, is a multi-mode optical fiber (MMF) having a core diameter of 50 μm and a clad outer diameter of 125 μm. Since the core diameter of the MMF is larger than a core diameter (for example, 10 μm) of a general single mode fiber (SMF), it is advantageous in that an optical signal emitted from the VSDEL 161 is easily coupled to a core.

The differential line (the electrical transmission path) 205 transmits information, which is output from the camera-side MCU (the transmitter-side control unit) 130, to the processing apparatus-side MCU (the receiver-side control unit) 350, and transmits information, which is output from the processing apparatus-side MCU (the receiver-side control unit) 350, to the camera-side MCU (the transmitter-side control unit) 130.

The differential line 206 transmits serial signals SerTC+/− from the processing apparatus-side connector case unit (the receiver unit) 300 to the camera-side connector case unit (the transmitter unit) 100.

The differential line 207 transmits serial signals SerTFG+/− from the camera-side connector case unit (the transmitter unit) 100 to the processing apparatus-side connector case unit (the receiver unit) 300.

The differential line 208 transmits the LVDS signal, which is output from the serializer 383 (which will be described later) of the processing apparatus-side connector case unit (the receiver unit) 300, to the deserializer 171 of the camera-side connector case unit (the transmitter unit) 100.

Next, the processing apparatus-side connector case unit (the receiver unit) 300 will be described. The processing apparatus-side connector case unit (the receiver unit) 300 includes a DC/DC converter 310, the light detecting unit 320, the current voltage conversion unit 330, the LVDS deserializer (the clock signal regeneration unit) 340, a clock generation unit 341, the processing apparatus-side MCU (the receiver-side control unit) 350, an external display LED 360, a level conversion unit 370, a clock generation unit 381, a DFF (Delay Flip-Flop) 382, and the serializer 383. Each unit of the processing apparatus-side connector case unit (the receiver unit) 300, for example, is accommodated in an MDR-26 connector case.

The DC/DC converter 310 converts a direct current voltage (+12 V) supplied from the processing apparatus (not illustrated) into a predetermined voltage, and uses the converted voltage as a positive power supply voltage VCC.

The light detecting unit 320, for example, is a PIN-type photodiode (PIN-PD) made of GaAs. The light detecting unit 320 receives the laser light input from the laser unit (the light source unit) 160 through the optical fiber (the optical transmission path) 204, and converts the light into a photodiode current IPD with conversion efficiency γ. Furthermore, when the power of the laser light input to the light detecting unit 320 is defined as PIN, the converted photodiode current IPD is expressed by the following Equation 2.

IPD=PIN/γ Equation 2

Next, the current voltage conversion unit 330 will be described. The current voltage conversion unit 330 generates an output voltage V_{TIAOUT} which is reduced as the photodiode current IPD output from the light detecting unit 320 is increased, and further converts the output voltage V_{TIAOUT} into a differential electrical signal DataOUT+/−. The current voltage conversion unit 330 outputs the converted differential electrical signal DataOUT+/− to the LVDS deserializer (the clock signal regeneration unit) 340.

Furthermore, the current voltage conversion unit 330 generates a monitor voltage V_{RXPWRMON} proportional to an average value of the photodiode current IPD output from the light detecting unit 320, and outputs the monitor voltage V_{RXPWRMON} to the processing apparatus-side MCU (the receiver-side control unit) 350.

Subsequently, the clock generation unit 341 generates a clock signal and outputs the clock signal to the LVDS deserializer (the clock signal regeneration unit) 340.

The LVDS deserializer (the clock signal regeneration unit) 340 converts the differential electrical signal DataOUT+/− input from the current voltage conversion unit 330 into four LVDS signals X0+/−, X1+/−, X2+/−, and X3+/− in synchronization with the input clock signal. The LVDS deserializer (the clock signal regeneration unit) 340 outputs the converted four LVDS signals and the clock signals XCLK+/− to the processing apparatus (not shown).

Next, the processing apparatus-side MCU (the receiver-side control unit) 350 will be described. The role of the processing apparatus-side MCU (the receiver-side control unit) 350 is to (1) acquire a reception power A/D value obtained by converting the monitor voltage V_{RXPWRMON} into a digital signal; (2) calculate a ratio of a reception power A/D value in an initial state held in advance in a ROM area (not illustrated) of a memory 353, which will be described later, with respect to the reception power A/D value; (3) light the external display LED 360 (which will be described later) when the ratio calculated in (2) is less than or equal to 0.6 or greater than or equal to 1.6; (4) acquire the LOCK information from the LVDS deserializer (the clock signal regeneration unit) 340; and (5) calculate the setting value of the bias current and the setting value of the modulation current from the temperature monitor A/D value which corresponds to a digital signal indicating the ambient temperature of the VCSEL 161, which is stored in a RAM area (not illustrated) of the memory 353 (which will be described later) from the camera-side MCU (the transmitter-side control unit) 130 through the inner link.

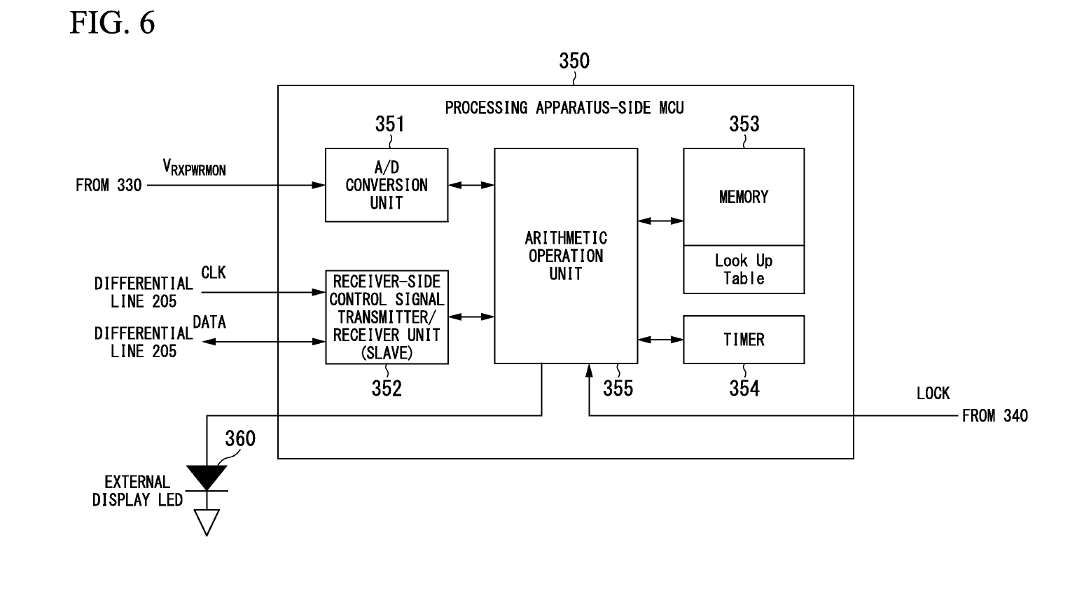

FIG. 6 is a functional block diagram of the processing apparatus-side MCU (the receiver-side control unit). The processing apparatus-side MCU (the receiver-side control unit) 350 includes an A/D conversion unit 351, a receiver-side control signal transmitter/receiver unit 352, the memory 353, a timer 354, and an arithmetic operation unit 355.

The A/D conversion unit 351 converts the monitor voltage V_{RXPWRMON} input from the current voltage conversion unit 330 into the reception power A/D value (a digital signal), and stores the converted reception power A/D value in the RAM area (not illustrated) of the memory 353 through the arithmetic operation unit 355.

The receiver-side control signal transmitter/receiver unit 352 (the slave) identifies the logic of an input data signal DATA based on a rising edge of the clock signal CLK output from the camera-side MCU (the transmitter-side control unit) 130 in the camera-side connector case unit (the transmitter unit) 100.

Furthermore, the receiver-side control signal transmitter/receiver unit 352 (the slave) holds the temperature monitor A/D value, which is received from the camera-side MCU (the transmitter-side control unit) 130 in the camera-side connector case unit (the transmitter unit) 100, in the RAM area (not illustrated) of the memory 353 through the arithmetic operation unit 355.

Furthermore, the receiver-side control signal transmitter/receiver unit 352 (the slave) outputs the LOCK signal input from the LVDS deserializer (the clock signal regeneration unit) 340, the information on the setting value of the bias current, and the information on the setting value of the modulation current at the request of the camera-side MCU (the transmitter-side control unit) 130 in the camera-side connector case unit (the transmitter unit) 100.

The memory 353 is divided into a RAM area (not illustrated) and a Flash ROM area (not illustrated), similarly to the memory 135 in the camera-side MCU. The RAM area (not illustrated) stores data to be primarily stored and the ROM area (not illustrated) stores a predetermined program to be executed by the arithmetic operation unit 355. Furthermore, the ROM area (not illustrated) of the memory 353 stores the reception power A/D value in the initial state (hereinafter referred to as an initial reception power A/D value), which has been measured in advance before the shipment of the data transmission device 1. The arithmetic operation unit 355 performs data exchange, instruction, monitoring of a state, and the like with respect to the memory 353, the timer 354, the receiver-side control signal transmitter/receiver unit 352 (the slave), and the A/D conversion unit 351 according to the program.

Furthermore, the ROM area (not illustrated) of the memory 353 stores a look up table, in which temperature information indicating the ambient temperature of the VCSEL 161 has been associated with the information on the setting values of the bias current and the modulation current in order to allow the processing apparatus-side MCU (the receiver-side control unit) 350 to adjust the bias current and the modulation current using the temperature monitor A/D value such that average light emission power and an extinction ratio are held to be constant regardless of temperature.

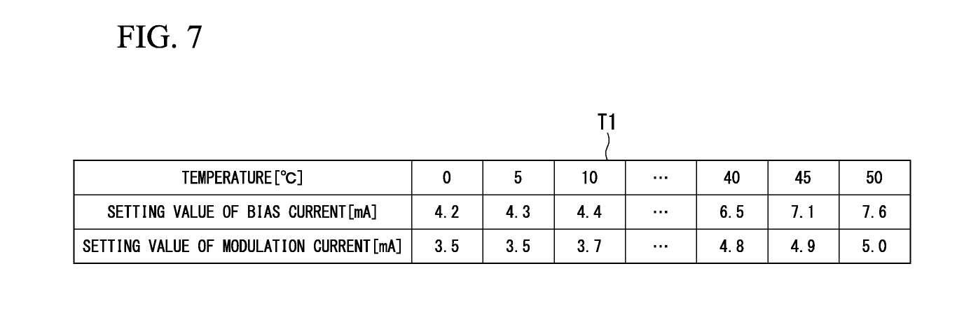

FIG. 7 is a diagram illustrating an example of the look up table stored in the memory of the processing apparatus-side MCU (the receiver-side control unit). In a table T1, the ambient temperature [° C.] of the laser unit (the light source unit) 160 and the setting values [mA] of the bias current and the modulation current are associated with each other in a one-to-one manner. The setting values of the bias current and the modulation current are set in the table T1 such that the average light emission power and the extinction ratio of the laser unit (the light source unit) 160 are constant. For example, in the memory 353, the information on each setting value of the bias current and the modulation current of the table T1 is stored with one byte.

Returning to FIG. 6, the timer 354 generates a request flag at a predetermined interval (for example, 10 ms). The arithmetic operation unit 355 always monitors the state of the flag, and starts a process of data exchange, A/D conversion, arithmetic operation and the like using the request flag as a trigger.

When power is applied, the arithmetic operation unit 355 starts to read a program from the ROM area (not illustrated) of the memory 353, initializes input/output signal terminals thereof according to a procedure of the program, initializes the A/D conversion unit 351, the receiver-side control signal transmitter/receiver unit 352 (the slave), and the timer 354, and starts to operate the timer 354.

Furthermore, the arithmetic operation unit 355 always monitors the request flag from the timer 354, and resets an initial timer value of the timer 354 using the generation of the request flag as a trigger.

Furthermore, the arithmetic operation unit 355 starts the operation of the A/D conversion unit 351, and stores the reception power monitor A/D value output by the A/D conversion unit 351 in the RAM area (not illustrated) of the memory 353.

Furthermore, the arithmetic operation unit 355 reads the initial reception power monitor A/D value stored in the ROM area (not illustrated) of the memory 353, and divides the reception power monitor A/D value by the initial reception power monitor A/D value.

When a value (the reception power A/D value/the initial reception power A/D value) after the division is less than or equal to 0.6 or greater than or equal to 1.6, the arithmetic operation unit 355 determines that the laser unit (the light source unit) 160 is abnormal, and lights the external display LED 360 by outputting a current to the external display LED 360. Meanwhile, when the value (the reception power A/D value/the initial reception power A/D value) after the division exceeds 0.6 and is smaller than 1.6, the arithmetic operation unit 355 determines that the laser unit (the light source unit) 160 is normal, and does not light the external display LED 360 by preventing a current from being output to the external display LED 360.

Furthermore, the arithmetic operation unit 355 performs the following processes at the request of the camera-side MCU (the transmitter-side control unit) 130 in the camera-side connector case unit (the transmitter unit) 100:

(1) The arithmetic operation unit 355 stores the temperature monitor A/D value, which is transmitted from the camera-side MCU (the transmitter-side control unit) 130 in the camera-side connector case unit (the transmitter unit) 100, in the RAM area (not illustrated) of the memory 353, reads the information on the setting value of the bias current and the setting value of the modification current, which correspond to the temperature monitor A/D value, from the table T1 of the ROM area (not illustrated) of the memory 353, and stores the information in the RAM area (not illustrated) of the memory 353;

(2) The arithmetic operation unit 355 controls the receiver-side control signal transmitter/receiver unit 352 (the slave) such that the setting value of the bias current and the setting value of the modification current stored in the RAM area (not illustrated) of the memory 353 are returned to the camera-side MCU (the transmitter-side control unit) 130 in the camera-side connector case unit (the transmitter unit) 100; and

(3) The arithmetic operation unit 355 acquires the LOCK signal output from the LVDS deserializer (the clock signal regeneration unit) 340, and controls the receiver-side control signal transmitter/receiver unit 352 (the slave) such that the LOCK signal is returned to the camera-side MCU (the transmitter-side control unit) 130 in the camera-side connector case unit (the transmitter unit) 100.

The external display LED 360 is lit by the current output from the arithmetic operation unit 355 when the laser unit (the light source unit) 160 is abnormal. In addition, the lighting state of the external display LED 360 may be changed based on a signal output from the arithmetic operation unit 355. For example, the external display LED 360 may be lit when it is normal or may flicker when it is abnormal. Furthermore, the external display LED 360 may be lit in green when it is normal or lit in red when it is abnormal using a two-color light emission LED.

When the input electrical signal to the camera-side connector case unit 100 is a signal having a variable transmission rate, like the video signal dealt with in the first preferred embodiment, the data transmission device 1 needs to allow the rate of the clock signal of the LVDS serializer (the test signal generation unit) 120 to coincide with the rate of the clock signal of the LVDS deserializer (the clock signal regeneration unit) 340 at a predetermined time interval according to the variable transmission rate. To this end, the data transmission device 1 exchanges a LOCK signal, which will be described later, between the LVDS serializer (the test signal generation unit) 120 and the LVDS deserializer (the clock signal regeneration unit) 340.

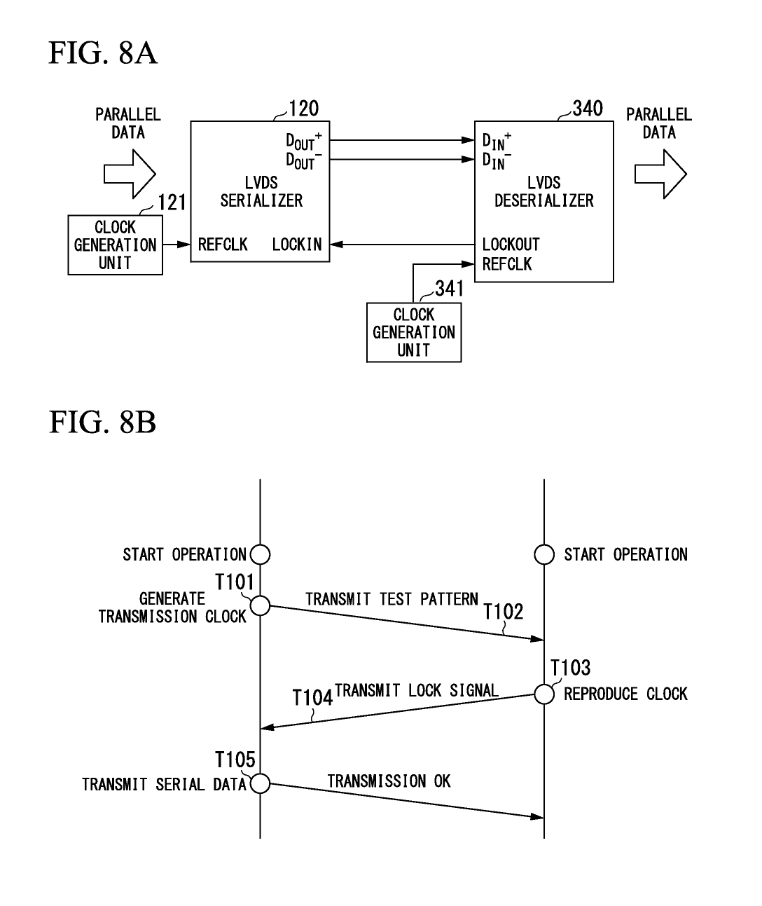

In this regard, an establishment procedure of synchronization between the LVDS serializer (the test signal generation unit) and the LVDS deserializer (the clock signal regeneration unit) will be described. FIG. 8A and FIG. 8B are diagrams for explaining the establishment procedure of the synchronization between the LVDS serializer (the test signal generation unit) and the LVDS deserializer (the clock signal regeneration unit). FIG. 8A is obtained by simplifying the data transmission device 1 illustrated in FIG. 1, in order to explain data exchange between the LVDS serializer (the test signal generation unit) and the LVDS deserializer (the clock signal regeneration unit). FIG. 8A illustrates the LVDS serializer (the test signal generation unit) 120, the LVDS deserializer (the clock signal regeneration unit) 340, the clock generation unit 121, and the clock generation unit 341.

In FIG. 8A, the clock generation unit 121 outputs a clock signal to the LVDS serializer (the test signal generation unit) 120. The LVDS serializer (the test signal generation unit) 120 generates a transmission clock from an input clock signal REFCLK, and outputs data D_{OUT}+/−, which is obtained by serializing parallel data input from the camera (not illustrated) synchronized with the transmission clock, toward the LVDS deserializer (the clock signal regeneration unit) 340. The LVDS deserializer (the clock signal regeneration unit) 340 regenerates a reception clock from a clock signal REFCLK input from the clock generation unit 341 and reception data, converts serial data D_{IN}+/− into parallel data in synchronization with the reception clock, and outputs the converted parallel data to the processing apparatus (not illustrated).

The LVDS deserializer (the clock signal regeneration unit) 340 outputs a LOCK signal (for example, High at the time of LOCK, Low at the time of UnLOCK), which notifies of the regeneration of the reception clock to be described later, toward the LVDS serializer (the test signal generation unit) 120.

The LVDS serializer (the test signal generation unit) 120 receives the LOCK signal from the LVDS deserializer (the clock signal regeneration unit) 340, and then outputs signals, which are obtained by serially converting data signals Xi+/− (i is an integer from 0 to 3) of 85 MHz input from the camera (not illustrated), to the LVDS deserializer (the clock signal regeneration unit) 340.

In order to enable serial transmission between the LVDS serializer (the test signal generation unit) 120 and the LVDS deserializer (the clock signal regeneration unit) 340, it is necessary for the LVDS deserializer (the clock signal regeneration unit) 340 to regenerate a reception clock from received data. For example, a description will be provided for a method for reproducing a reception clock using a test pattern transmitted from the LVDS serializer (the test signal generation unit) 120.

FIG. 8B is a timing chart illustrating the establishment of synchronization between the LVDS serializer (the test signal generation unit) and the LVDS deserializer (the clock signal regeneration unit). First, after power is applied, the LVDS serializer (the test signal generation unit) 120 generates a transmission clock using a reference clock (T101). After the generation of the transmission clock is completed, the LVDS serializer (the test signal generation unit) 120 transmits a test pattern (for example, a continuous signal with a fixed period 01) toward the LVDS deserializer (the clock signal regeneration unit) 340 (T102).

The LVDS deserializer (the clock signal regeneration unit) 340 regenerates a clock using the received continuous signal (T103). After the generation of the clock is completed, the LVDS deserializer (the clock signal regeneration unit) 340 notifies the LVDS serializer (the test signal generation unit) 120 of the completion of the clock regeneration (a LOCK signal, for example, High at the time of LOCK, Low at the time of UnLOCK) (T104). The LVDS serializer (the test signal generation unit) 120 receives the LOCK signal from the LVDS deserializer (the clock signal regeneration unit) 340, and transmits original data (T105). The procedure of the present timing chart thus ends.

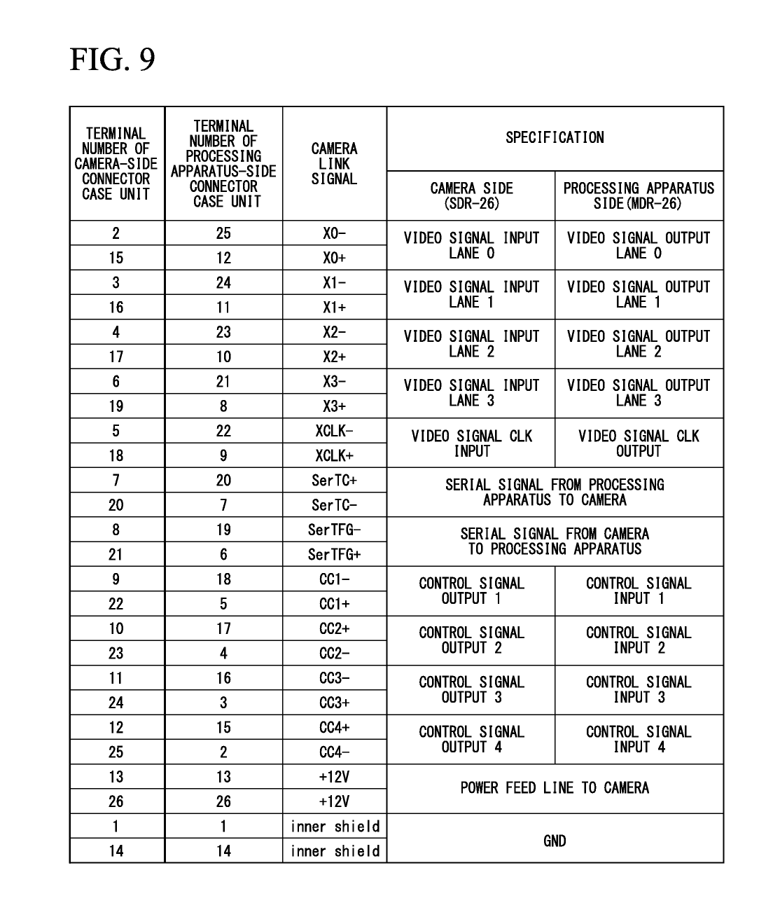

FIG. 9 is a table for explaining an example of pin arrangement of input/output terminals of the data transmission device. In FIG. 9, terminal numbers of the camera-side connector case unit (the transmitter unit) 100, terminal numbers of the processing apparatus-side connector case unit (the receiver unit) 300, camera link signals, specifications of a camera side (SDR-26), and specifications of a processing apparatus side (MDR-26) are associated with one another.

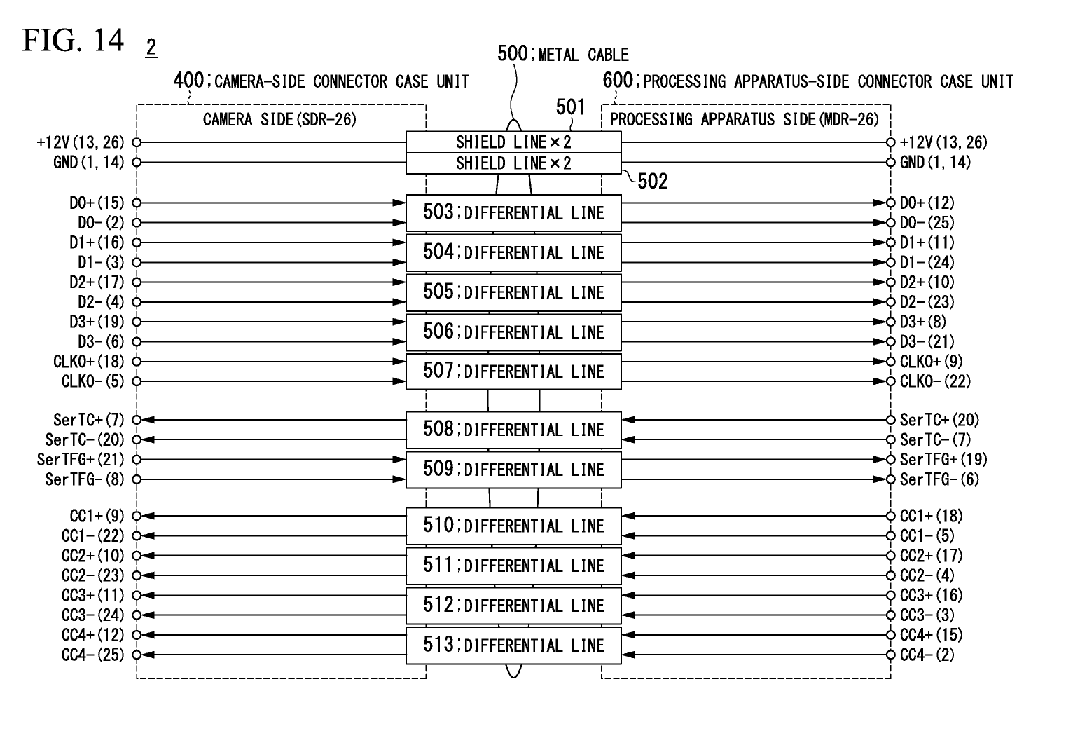

The terminals of the camera-side connector case unit (the transmitter unit) 100 have the same configuration as the terminals of the camera side of the camera link interface in the related art illustrated in FIG. 14. The camera-side connector case unit (the transmitter unit) 100 has four pairs of differential video signal input terminals (terminal numbers 2, 15, 3, 16, 4, 17, 6, and 19), one pair of differential clock signal input terminals (terminal numbers 5 and 18), one pair of differential serial signal output terminals (terminal numbers 7 and 20), one pair of differential serial signal input terminals (terminal numbers 8 and 21), four pairs of control signal output terminals (terminal numbers 9, 22, 10, 23, 11, 24, 12, and 25), two output terminals (terminal numbers 13 and 26) for supplying power of 12 V to the camera, and two GND terminals (terminal numbers 1 and 14).

Similarly, the processing apparatus-side connector case unit (the receiver unit) 300 has four pairs of differential video signal output terminals (terminal numbers 25, 12, 24, 11, 23, 10, 21, and 8), one pair of differential clock signal output terminals (terminal numbers 22 and 9), one pair of differential serial signal input terminals (terminal numbers 20 and 7), one pair of differential serial signal output terminals (terminal numbers 19 and 6), four pairs of control signal output terminals (terminal numbers 18, 5, 17, 4, 16, 3, 15, and 2), two input terminals (terminal numbers 13 and 26) for receiving power of 12 V from the processing apparatus, and two GND terminals (terminal numbers 1 and 14).

The data transmission device 1 transmits the video signals Xi+/− (i is an integer from 0 to 3) from a lane i of the video signal input terminals (an LVDS interface) of the camera-side connector case unit 100 to a lane i of the video signal output terminals (an LVDS interface) of the processing apparatus-side connector case unit 300. The data transmission device 1 transmits the clock signals XCLK+/− from the clock input terminals of the camera-side connector case unit 100 to the clock output terminals of the processing apparatus-side connector case unit 300.

The data transmission device 1 transmits the serial signals SerTC+/− from the serial signal input terminals of the processing apparatus-side connector case unit 300 to the serial signal output terminals of the camera-side connector case unit 100. Meanwhile, the data transmission device 1 transmits the serial signals SerTFG+/− from the serial signal input terminals of the camera-side connector case unit 100 to the serial signal output terminals of the processing apparatus-side connector case unit 300.

The data transmission device 1 transmits the control signals CCk+/− (k is an integer from 1 to 4) from the control signal input terminals of the processing apparatus-side connector case unit 300 to the control signal output terminals of the camera-side connector case unit 100. The data transmission device 1 supplies power of 12 V, which is supplied from the processing apparatus, from the input terminals (terminal numbers 13 and 26) of the processing apparatus-side connector case unit 300 to the output terminals (terminal numbers 13 and 26) of the camera-side connector case unit 100, respectively.

Furthermore, the GND terminals (terminal numbers 1 and 14) of the camera-side connector case unit 100 are connected to the GND terminals (terminal numbers 1 and 14) of the processing apparatus-side connector case unit 300.

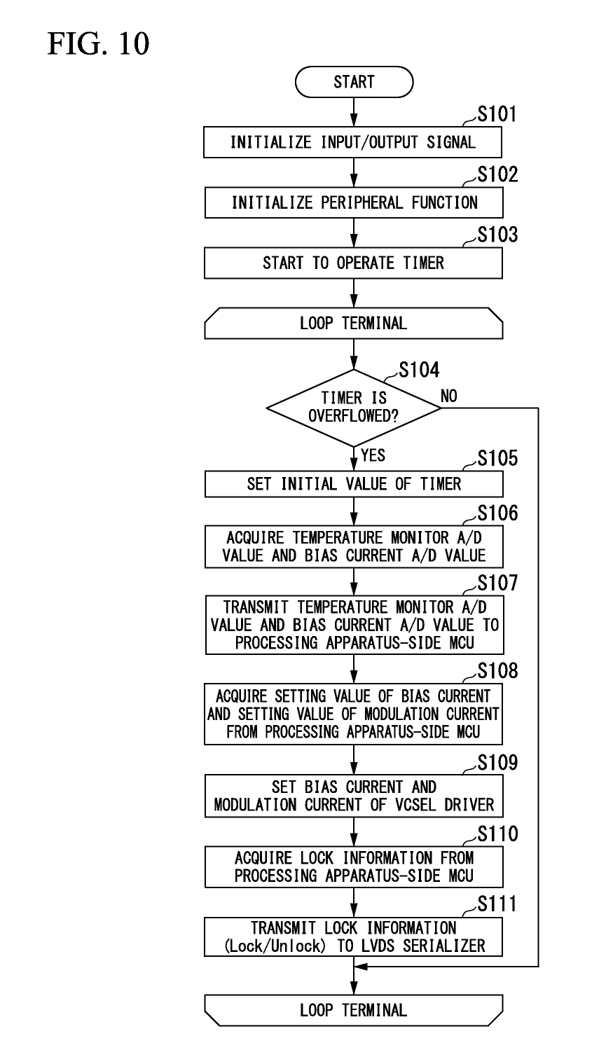

FIG. 10 is a flowchart illustrating the flow of the process of the camera-side MCU (the transmitter-side control unit). First, the camera-side MCU (the transmitter-side control unit) 130 initializes input/output signals (step S101). Next, the camera-side MCU (the transmitter-side control unit) 130 initializes peripheral functions (the transmitter-side control signal transmitter/receiver unit (the master) 132, the A/D conversion unit 131, the D/A conversion unit 134, and the timer 136) (step S102). Next, the camera-side MCU (the transmitter-side control unit) 130 starts to operate the timer 136 therein (step S103).

The camera-side MCU (the transmitter-side control unit) repeats the following processes from step S104 to step S111. First, the camera-side MCU (the transmitter-side control unit) 130 determines whether the timer 136 has exceeded a predetermined time (for example, 10 ms) (timer overflow) (step S104). When the timer 136 is not overflowed (NO in step S104), the camera-side MCU (the transmitter-side control unit) 130 further waits for the passage of the time. Meanwhile, when the timer 136 is overflowed (YES in step S104), the camera-side MCU (the transmitter-side control unit) 130 sets the timer 136 to an initial value (step S105).

Next, the camera-side MCU (the transmitter-side control unit) 130 acquires a present temperature monitor A/D value and a bias current A/D value of the laser unit (the light source unit) 160 (step S106). Next, the camera-side MCU (the transmitter-side control unit) 130 transmits a write request of the temperature monitor A/D value and the bias current A/D value to the processing apparatus-side MCU (the receiver-side control unit) 350 through the inner link (step S107).

Next, the camera-side MCU (the transmitter-side control unit) 130 transmits a read request of the information on the setting value of the bias current and the information on the setting value of the modulation current to the processing apparatus-side MCU (the receiver-side control unit) 350, and holds the information on the setting values returned by the processing apparatus-side MCU (the receiver-side control unit) 350 in the RAM area (not illustrated) of the memory 135 (step S108).

Next, the camera-side MCU (the transmitter-side control unit) 130 outputs a current DAC0 and a current DAC1, which correspond to a bias current and a modulation current to be output from the laser driving unit (the light source driving unit) 140, from the information on the setting values stored in the RAM area (not illustrated) of the memory 135 (step S109).

Next, the camera-side MCU (the transmitter-side control unit) 130 transmits a read request of the LOCK information to the processing apparatus-side MCU (the receiver-side control unit) 350, and receives the LOCK information which is returned by the processing apparatus-side MCU (the receiver-side control unit) 350 (step S110). Then, the camera-side MCU (the transmitter-side control unit) 130 outputs the received LOCK information to the LVDS serializer (the test signal generation unit) 120 (step S111). Thus, the LVDS serializer (the test signal generation unit) 120 outputs data to be originally transmitted to the laser driving unit (the light source driving unit) 140, and allows the processing apparatus-side connector case unit (the receiver unit) 300 to transmit data. The procedure of the present flowchart thus ends.

Consequently, the data transmission device 1 is able to efficiently transmit/receive the transmitter/receiver signal and the LOCK signal, which correspond to information on physical quantities having a relation to the intensity of an optical signal, without a mutual collision.

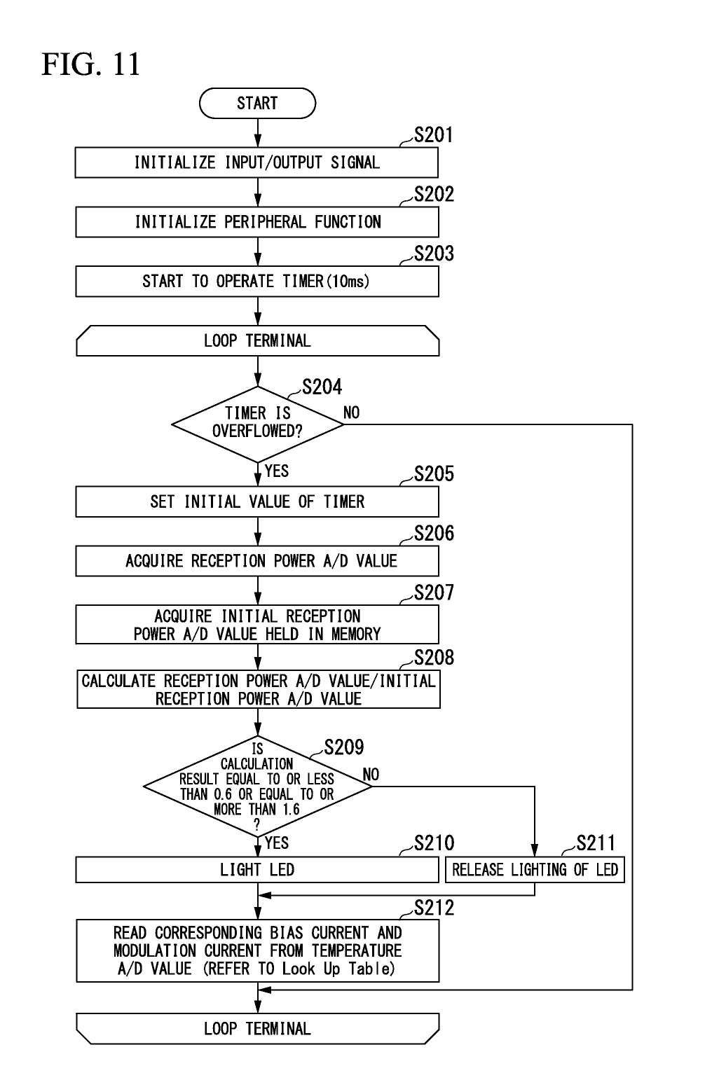

FIG. 11 is a flowchart illustrating the flow of the process of the processing apparatus-side MCU (the receiver-side control unit). The processing apparatus-side MCU (the receiver-side control unit) 350 initializes input/output signals (step S201). Next, the processing apparatus-side MCU (the receiver-side control unit) 350 initializes peripheral functions (the receiver-side control signal transmitter/receiver unit (slave) 352, the A/D conversion unit 351, and the timer 354) (step S202). Next, the processing apparatus-side MCU (the receiver-side control unit) 350 starts to operate the timer 354 therein (step S203).

The processing apparatus-side MCU (the receiver-side control unit) repeats the following processes from step S204 to step 212. First, the processing apparatus-side MCU (the receiver-side control unit) 350 determines whether the timer 354 has exceeded a predetermined time (10 ms) (timer overflow) (step S204). When the timer 354 is not overflowed (NO in step S204), the processing apparatus-side MCU (the receiver-side control unit) 350 further waits for the passage of the time. Meanwhile, when the timer 354 is overflowed (YES in step S204), the processing apparatus-side MCU (the receiver-side control unit) 350 sets the timer 354 to an initial value (step S205).

Next, the processing apparatus-side MCU (the receiver-side control unit) 350 acquires a reception power A/D value based on reception power of received laser light (step S206). Next, the processing apparatus-side MCU (the receiver-side control unit) 350 reads the initial reception power A/D value stored in the memory 353 (step S207). Next, the processing apparatus-side MCU (the receiver-side control unit) 350 calculates the reception power A/D value/the initial reception power A/D value (step S208).

When the calculation result (the reception power A/D value/the initial reception power A/D value) is less than or equal to 0.6 or greater than or equal to 1.6 (YES in step S209), the processing apparatus-side MCU (the receiver-side control unit) 350 lights the external display LED 360 by outputting a current to the external display LED 360 (step S210). Meanwhile, when the calculation result (the reception power A/D value/the initial reception power A/D value) exceeds 0.6 and is smaller than 1.6 (NO in step S209), the processing apparatus-side MCU (the receiver-side control unit) 350 does not light the external display LED by preventing a current from being output to the external display LED (step S211).

Next, the processing apparatus-side MCU (the receiver-side control unit) 350 reads setting values of a bias current and a modulation current, which correspond to a temperature monitor A/D value and a reception power A/D value, from the ROM area (not illustrated) of the memory 353 using the temperature monitor A/D value, which is stored in the RAM area (not illustrated) of the memory 353, by an interrupt process (which will be described later) which is started by a signal transmitted from the camera-side MCU (the transmitter-side control unit) 130 through the inner link (step S212). The procedure of the present flowchart thus ends.

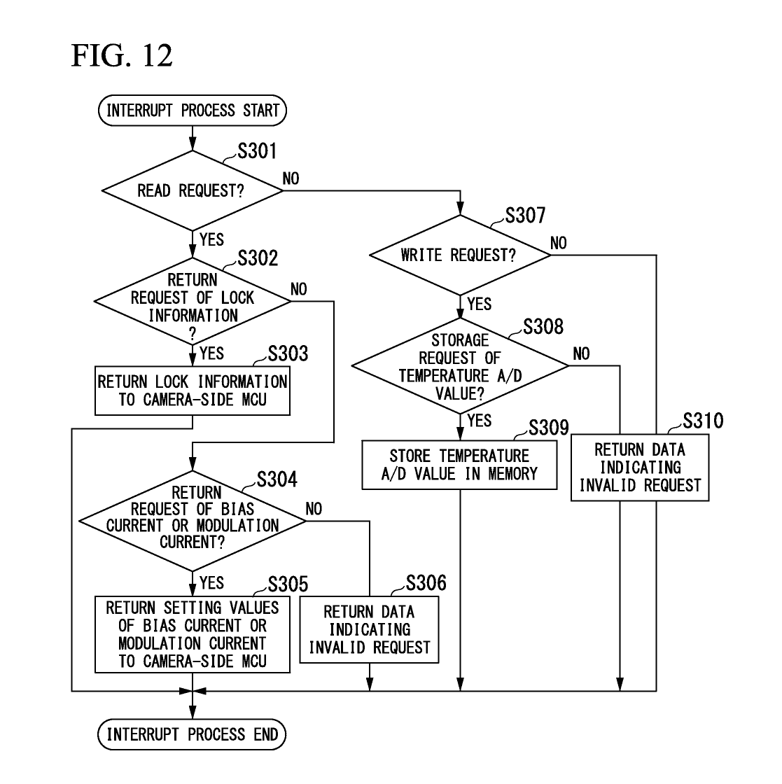

FIG. 12 is a flowchart illustrating the flow of the process of the processing apparatus-side MCU (the receiver-side control unit) at the time of interrupt in accordance with the first preferred embodiment of the present invention. The receiver-side control signal transmitter/receiver unit 352 of the processing apparatus-side MCU (the receiver-side control unit) 350 receives the signal transmitted from the camera-side MCU (the transmitter-side control unit) 130 through the inner link, so that an interrupt process (an exceptional process) is started. First, the processing apparatus-side MCU (the receiver-side control unit) 350 determines whether the signal transmitted from the camera-side MCU (the transmitter-side control unit) 130 is a read request (step S301). When the signal is the read request (YES in step S301) and is a return request of LOCK information (YES in step S302), the processing apparatus-side MCU (the receiver-side control unit) 350 returns the LOCK information of the LVDS deserializer (the clock signal regeneration unit) 340 to the camera-side MCU (the transmitter-side control unit) (step S303).

Meanwhile, when the signal transmitted from the camera-side MCU (the transmitter-side control unit) 130 is not the return request of the LOCK information (NO in step S302), the processing apparatus-side MCU (the receiver-side control unit) 350 determines whether the signal transmitted from the camera-side MCU (the transmitter-side control unit) 130 is a return request of the bias current and the modulation current (step S304). When the signal transmitted from the camera-side MCU (the transmitter-side control unit) 130 is the return request of the bias current and the modulation current (YES in step S304), the processing apparatus-side MCU (the receiver-side control unit) 350 returns information on the setting value of the bias current and information on the setting value of the modulation current to the camera-side MCU (the transmitter-side control unit) 130 (step S305). Meanwhile, when the signal transmitted from the camera-side MCU (the transmitter-side control unit) is not the return request of the bias current and the modulation current (NO in step S304), the processing apparatus-side MCU (the receiver-side control unit) 350 returns data (for example, 0xFF) indicating that the signal is an invalid request (step S306).

Returning to step S301, when the signal transmitted from the camera-side MCU (the transmitter-side control unit) 130 is not the read request (NO in step S301), the processing apparatus-side MCU (the receiver-side control unit) 350 determines whether the signal is a write request (step S307). When the signal is not the write request (NO in step S307), the processing apparatus-side MCU (the receiver-side control unit) 350 returns data (for example, 0xFF) indicating that the signal is an invalid request (step S310).

Meanwhile, when the signal is the write request (YES in step S307) and is a storage request of a temperature monitor A/D value (YES in step S308), the processing apparatus-side MCU (the receiver-side control unit) 350 stores the temperature monitor A/D value in the RAM area (not illustrated) of the memory 353 (step S309). Meanwhile, when the signal is not the storage request of the temperature monitor A/D value (NO in step S308), the processing apparatus-side MCU (the receiver-side control unit) 350 returns data (for example, 0xFF) indicating that the signal is an invalid request (step S310). The procedure of the present flowchart thus ends.

So far, according to the first preferred embodiment, the processing apparatus-side MCU (the receiver-side control unit) 350 compares an optical power A/D value reflecting present optical output with an initial optical power A/D value. When the present optical output is out of a predetermined range decided using the initial optical power A/D value as a reference, the processing apparatus-side MCU (the receiver-side control unit) 350 lights the LED, thereby notifying of the abnormality of the laser unit (the light source unit) 160.

That is, the processing apparatus-side MCU (the receiver-side control unit) 350 is able to determine the abnormality of the light source unit based on information indicating the power of light received in the light detecting unit 320. Moreover, the data transmission device is able to collect information in the receiver side, so that it is possible to reduce the circuit size of the camera-side connector case unit 100.

Furthermore, since the processing apparatus-side MCU (the receiver-side control unit) 350 of the processing apparatus-side connector case unit 300 is able to control light emission power of the laser unit (the light source unit) 160, it is not necessary to mount a monitor PD for measuring optical power of the laser unit (the light source unit) 160 in the camera-side connector case unit 100. Consequently, it is possible to reduce the circuit size of the camera-side connector case unit 100.

In addition, according to the first preferred embodiment, even when the light detecting unit 320 is abnormal, since the photodiode current IPD output from the light detecting unit 320 is changed and thus the monitor voltage V_{RXPWRMON} is changed, the present optical power A/D value is out of the predetermined range decided using the initial optical power A/D value as a reference. Consequently, according to the first preferred embodiment, when one of the laser unit (the light source unit) 160 and the light detecting unit 320 is abnormal or both of them are abnormal, the data transmission device 1 is able to notify of the abnormality externally.

In the case of a signal having a variable transmission rate (for example, a video signal), in order to enable serial transmission between the LVDS serializer 120 and the LVDS deserializer 340, it is necessary to transmit the LOCK signal toward the LVDS serializer (the test signal generation unit) 120 from the LVDS deserializer (the clock signal regeneration unit) 340. At this time, the data transmission device allows an electrical transmission path for transmitting the LOCK signal and an electrical transmission path for transmitting the temperature monitor A/D value and the bias current A/D value to be common by the electrical transmission path 205, so that it is possible to omit an electrical transmission path.

In addition, when the monitor PD receives unit of the optical output from the VCSEL and the laser unit (the light source unit) 160 has a function (Auto Power Control, APC) of adjusting a bias current such that a monitor PD output current is constant, if the laser unit (the light source unit) 160 enters a deterioration state, since a bias current A/D value is increased, the processing apparatus-side MCU (the receiver-side control unit) 350 may determine the abnormality of the laser unit (the light source unit) 160 through a change in the bias current A/D value.

In detail, for example, the camera-side connector case unit (the transmitter unit) 100 includes the monitor PD (a light detection unit) for detecting the optical power of an optical signal output from the laser unit (the light source unit) 160, and the laser driving unit (the light source driving unit) 140 for controlling the bias current output to the light source unit such that the optical power detected by the monitor PD (a light detection unit) is constant. The camera-side MCU (the transmitter-side control unit) 130 transmits the bias current A/D value, which corresponds to information indicating the bias current output from the laser driving unit (the light source driving unit) 140 to the laser unit (the light source unit) 160, to the processing apparatus-side MCU (the receiver-side control unit) 350 through the inner link.

The processing apparatus-side MCU (the receiver-side control unit) 350 divides the received bias current A/D value by a reference bias current A/D value (for example, 5.5 mA), and determines that the laser unit (the light source unit) 160 is abnormal when a value obtained by the division is less than or equal to 0.6 (3.3 mA or less) or greater than or equal to 1.6 (8.8 mA or more). This range is obtained by considering a change in the bias current in order to allow the optical power of the laser unit (the light source unit) 160 to be constant regardless of temperature.

Consequently, the data transmission device 1 is able to determine the abnormality of the laser unit (the light source unit) 160 based on the information indicating the bias current.

Furthermore, the processing apparatus-side MCU (the receiver-side control unit) 350 may determine the abnormality of the laser unit (the light source unit) 160 based on information indicating the power of light received in the light detecting unit 320, and information indicating the ambient temperature of the laser unit (the light source unit) 160.

For example, when a bias current I_{BIAS} is constant, reception power P(T) at temperature T is expressed by the following Equation 3 employing reception power P0 at a reference temperature and a temperature variation coefficient f(T) of light emission power as arguments.

P(T)=f(T)×P0 Equation 3

In Equation 3 above, f(T) denotes a polynomial expression for T.

The processing apparatus-side MCU (the receiver-side control unit) 350 stores Equation 3 in the ROM area of the memory 353 together with P0. The processing apparatus-side MCU (the receiver-side control unit) 350 calculates P0 at the reference temperature from Equation 3 using the information P (T) indicating the power of the light received in the light detection unit and the ambient temperature T of the laser unit (the light source unit) 160, which is one of physical quantities having a relation to the light emission power.

The processing apparatus-side MCU (the receiver-side control unit) 350 calculates P0/P0Init which is a ratio of P0 to reception power P0Init in an initial state, and determines that the laser unit (the light source unit) 160 is abnormal when the calculated ratio P0/P0Init is out of a predetermined range (for example, P0/P0Init is less than or equal to 0.6 or greater than or equal to 1.6).

Consequently, even when the light emission power of the laser unit (the light source unit) 160 is changed by the physical quantity (for example, ambient temperature) having a relation to the light emission power of the laser unit (the light source unit) 160, the processing apparatus-side MCU (the receiver-side control unit) 350 is able to determine the abnormality of the laser unit (the light source unit) 160.

In addition, in this method, even when the light detecting unit 320 is abnormal, P0/P0Init is out of the predetermined range. Consequently, when one of the laser unit (the light source unit) 160 and the light detecting unit 320 is abnormal or both of them are abnormal, the data transmission device 1 is able to notify of the abnormality externally.

Furthermore, the processing apparatus-side MCU (the receiver-side control unit) 350 may determine the abnormality of the laser unit (the light source unit) 160 based on the temperature monitor A/D value indicating the ambient temperature of the laser unit (the light source unit) 160, which is one of the physical quantities having a relation to the light emission power of the laser unit (the light source unit) 160. For example, when a ratio of a reference temperature monitor A/D value to a present temperature monitor A/D value is out of a predetermined range, the processing apparatus-side MCU (the receiver-side control unit) 350 may determine that the laser unit (the light source unit) 160 is abnormal.

### Second Preferred Embodiment

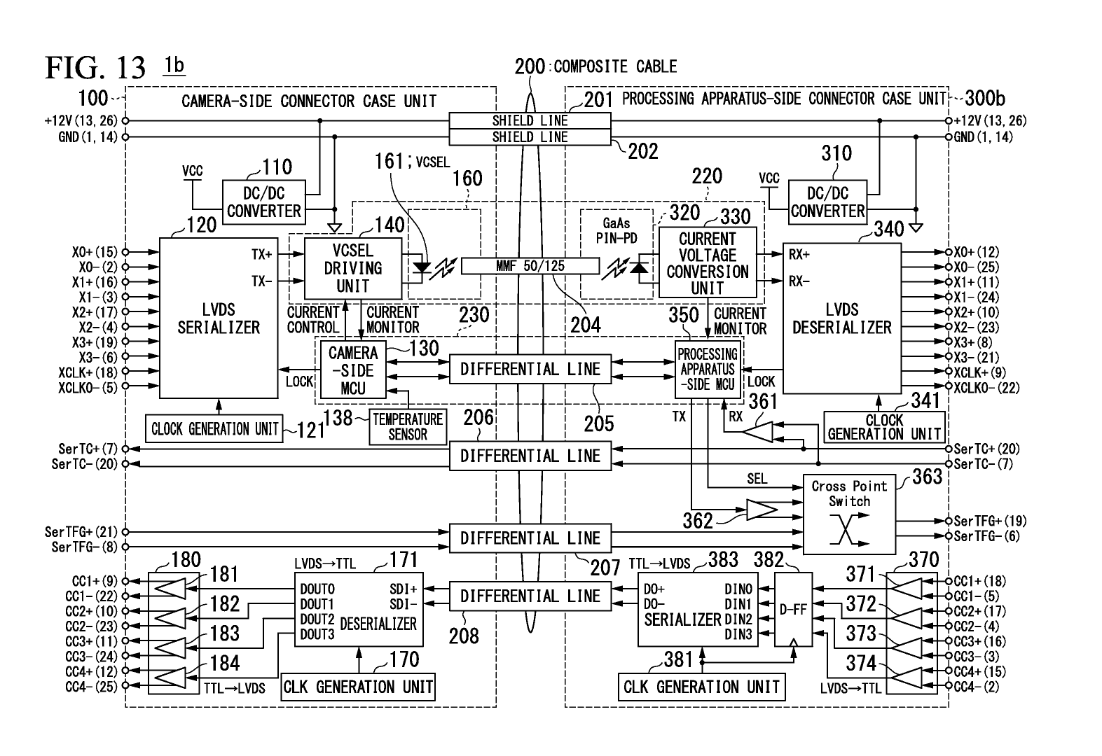

Next, a second preferred embodiment of the present invention will be described. FIG. 13 is a functional block diagram of a data transmission device in accordance with the second preferred embodiment of the present invention. In addition, the same reference numerals are used to designate elements common in FIG. 1, and a description thereof will be omitted.

A processing apparatus-side connector case unit (a receiver unit) 300b in the configuration of a data transmission device 1b further includes a buffer 361, a buffer 362, and a cross point switch 363 which are additionally provided to the processing apparatus-side connector case unit (the receiver unit) 300 of FIG. 1, as compared with the first preferred embodiment, wherein the buffer 361 converts an LVDS level input into a TTL level output and the buffer 362 converts a TTL level input into an LVDS level output. In an initial state after power is applied, the cross point switch 363 is set to output a signal, which is input from a camera (not illustrated), to a processing apparatus (not illustrated).

The buffer 361 converts an LVDS level of a control signal from the processing apparatus (not illustrated) to the camera (not illustrated) into a TTL level, and inputs output RX thereof to a processing apparatus-side MCU (a receiver-side control unit) 350. The processing apparatus-side MCU (the receiver-side control unit) 350 always receives a signal from the processing apparatus (not illustrated). When a request for returning information on a calculation result indicating the state of a laser unit (a light source unit) 160 is received from the processing apparatus (not illustrated), the processing apparatus-side MCU (the receiver-side control unit) 350 outputs a signal SEL for switching the cross point switch 363 such that a signal input from the processing apparatus-side MCU (the receiver-side control unit) 350 is output to the processing apparatus (not illustrated).

Since an output signal TX from the processing apparatus-side MCU (the receiver-side control unit) 350 has a TTL level, the output signal TX is converted into an LVDS level output using the buffer 362. The output of the buffer 362 is input to the cross point switch 363. The processing apparatus-side MCU (the receiver-side control unit) 350 outputs the information (for example, an abnormal state 0x01, a normal state 0x00) on the calculation result indicating the state of the laser unit (the light source unit) 160 to the processing apparatus (not illustrated).

So far, according to the second preferred embodiment, since the cross point switch is arranged in a serial communication line between the processing apparatus and the camera, when the processing apparatus inquires about the presence or absence of the abnormality of the laser unit (the light source unit) 160, the processing apparatus-side MCU (the receiver-side control unit) 350 is able to broadcast information on the presence or absence of the abnormality through the serial communication line. As a consequence, the processing apparatus displays the fact that a display is abnormal or allows a speaker to output an alert sound, thereby broadcasting the abnormality of the laser unit (the light source unit) 160 to users.

In addition, the preferred embodiment of the present invention is described by using the VCSEL as a laser. However, the present invention is not limited thereto. For example, it may be possible to use another semiconductor laser (for example, a Fabry-Perot Laser diode (FP-LD) or a Distributed-Feedback Laser diode (DFB-LD).

As used herein, the following directional terms “forward, rearward, above, downward, right, left, vertical, horizontal, below, transverse, row and column” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without deuniting from the scope of the present invention.

The present invention can be extensively applied to a data transmission device that transmits/receives an optical signal, a data transmission method, and a data transmission device control program, and a receiver side of the optical signal is able to determine the abnormality of optical units of a transmission side.

What is claimed is:

1. A data transmission device comprising:
a transmitter unit;
a receiver unit;
an optical transmission path that connects the transmitter unit to the receiver unit and transmits an optical signal; and
an electrical transmission path that connects the transmitter unit to the receiver unit and transmits an electrical signal, wherein
the transmitter unit comprises:
a light source unit that converts an input electrical signal from an exterior into an optical signal, and outputs the optical signal to the optical transmission path; and
a transmitter-side control unit that outputs information on a physical quantity having a relation to intensity of the optical signal, which is output from the light source unit, to the electrical transmission path, and
the receiver unit comprises:
a light detecting unit that receives the optical signal transmitted through the optical transmission path and converts the optical signal into an electrical signal; and
a receiver-side control unit that receives the information on the physical quantity transmitted through the electrical transmission path, and determines abnormality of the light source unit based on the received information on the physical quantity.

2. The data transmission device according to claim 1, wherein
the transmitter unit further comprises a light source driving unit that controls a bias current output to the light source unit,
the information on the physical quantity is information indicating ambient temperature of the light source unit,
the receiver-side control unit transmits a setting value of the bias current for controlling the intensity of the optical signal of the light source unit to the transmitter-side control unit based on the received information indicating the ambient temperature,
the transmitter-side control unit controls the light source driving unit based on the setting value of the bias current received from the receiver-side control unit, and
the receiver-side control unit determines the abnormality of the light source unit based on information on the intensity of the optical signal received in the light detecting unit.

3. The data transmission device according to claim 2, wherein,
when an intensity ratio of an optical signal at a present time to intensity of a reference optical signal is out of a predetermined range, the receiver-side control unit determines that the light source unit is abnormal.

4. The data transmission device according to claim 1, wherein
the transmitter unit further comprises:
a light detection unit that detects the intensity of the optical signal output from the light source unit; and
a light source driving unit that controls a bias current output to the light source unit such that the intensity of the optical signal detected by the light detection unit is constant,
the information on the physical quantity is information indicating the bias current of the light source unit, and
the receiver-side control unit determines the abnormality of the light source unit based on information indicating the received bias current.

5. The data transmission device according to claim 4, wherein,
when a bias current ratio at a present time to a reference bias current is out of a predetermined range, the receiver-side control unit determines that the light source unit is abnormal.

6. The data transmission device according to claim 1, wherein
the information on the physical quantity is information indicating ambient temperature of the light source unit, and
the receiver-side control unit adjusts the intensity of the received optical signal to intensity of an optical signal at a reference temperature based on the information indicating the ambient temperature, and determines the abnormality of the light source unit based on information indicating the adjusted intensity of the optical signal.

7. The data transmission device according to claim 6, wherein,
when a ratio of the adjusted intensity of the optical signal at a present time to intensity of a reference optical signal is out of a predetermined range, the receiver-side control unit determines that the light source unit is abnormal.

8. The data transmission device according to claim 1, wherein,
when an input electrical signal from an exterior is a signal having a variable transmission rate, the transmitter unit further comprises a test signal generation unit that generates an electrical signal for a test in synchronization with a clock signal,
the light source unit converts the electrical signal for a test generated by the transmitter unit into an optical signal for a test, and outputs the optical signal for a test to the optical transmission path,
the receiver unit receives the optical signal for a test transmitted through the optical transmission path, and converts the optical signal for a test into the electrical signal for a test,
the light detecting unit further comprises a clock signal regeneration unit that regenerates the clock signal from the electrical signal for a test converted by the light detecting unit,
when it is possible to regenerate the clock signal, the clock signal regeneration unit transmits a completion signal indicating completion of regeneration of the clock signal to the receiver-side control unit,
the receiver-side control unit outputs the completion signal transmitted by the clock signal regeneration unit to the electrical transmission path, and
the transmitter-side control unit transmits the completion signal transmitted through the electrical transmission path to the test signal generation unit.

9. The data transmission device according to claim 1, further comprising:
a light emitting element that emits light,
wherein the receiver-side control unit performs control such that a lighting state of the light emitting element is changed when it is determined that the light source unit is abnormal.

10. The data transmission device according to claim 1, further comprising:
a switch unit that outputs a signal input from the receiver-side control unit to an external apparatus, and wherein,
when information indicating the abnormality of the light source unit is requested, the receiver-side control unit performs control such that the information is output to the external apparatus through the switch unit.

11. A data transmission method performed in the data transmission device according to claim 1, comprising:
a transmitter-side control sequence of outputting information on a physical quantity having a relation to intensity of an optical signal, which is output from the light source unit, to the electrical transmission path; and
a receiver-side control sequence of receiving the information on the physical quantity transmitted through the electrical transmission path, and determining abnormality of the light source unit based on the received information on the physical quantity.

12. A data transmission device control program for causing a computer of a receiver-side control unit of a receiver unit in a data transmission device to perform:
receiving information on a physical quantity transmitted through an electrical transmission path, and determining abnormality of a light source unit based on the received information on the physical quantity, and wherein
the data transmission device comprises:
a transmitter unit;
the receiver unit; and
the electrical transmission path that connects the transmitter unit to the receiver unit and transmits an electrical signal, and
the transmitter unit comprises:
the light source unit that converts an input electrical signal from an exterior into an optical signal, and outputs the optical signal to the optical transmission path; and
a transmitter-side control unit that outputs the information on the physical quantity having a relation to intensity of the optical signal, which is output from the light source unit, to the electrical transmission path.
